(19) United States
(12) Patent Application Publication
(10) Pub. No.: US 2024/0293973 A1
(43) Pub. Date: Sep. 5, 2024

(54) 3D Printed Multiport Vacuum Chamber

(71) Applicant: University of the Incarnate Word, San Antonio, TX (US)

(72) Inventors: Rosa Elia Cardenas, San Antonio, TX (US); Angel Joaquin Perez Linde, San Antonio, TX (US)

(21) Appl. No.: 18/594,818

(22) Filed: Mar. 4, 2024

Related U.S. Application Data
(60) Provisional application No. 63/488,366, filed on Mar. 3, 2023.

(51) Int. Cl. B29C 64/386; B29C 64/124; B29C 64/188; B29K 63/00; B29K 105/00; B33Y 10/00; B33Y 40/20; B33Y 50/00; B33Y 70/00; B33Y 80/00

(52) U.S. Cl. CPC B29C 64/386; B29C 64/124; B29C 64/188; B33Y 10/00; B33Y 40/20; B33Y 50/00; B33Y 80/00; B29K 2063/00; B29K 2105/0088; B33Y 70/00

(57) ABSTRACT

A photopolymer resin multiport vacuum chamber capable of holding vacuum down to a level below 30 mTorr in a range of temperatures near room temperature of 300 K and 2 mTorr at low temperatures of 2 K and the manufacturing method using Vat Photopolymerization additive manufacturing techniques are the subject of protection in the following invention patent application. Safety issues solutions for uses with pressurized gasses are considered. The vacuum chamber presents one or several vacuum ports that are compatible with KF and/or ISO standard fittings, so it is easily connected with KF/ISO standard transfer lines and vacuum ports in addition to a pressure safety release valve. It also includes a port for easy adhesion to standard PVC piping and/or metal tubing

### CROSS-REFERENCES TO RELATED APPLICATIONS

This application is a continuation-in-part of U.S. application Ser. No. tk.

### STATEMENT REGARDING FEDERALLY SPONSORED RESEARCH OR DEVELOPMENT

Not applicable.

### BACKGROUND OF THE INVENTION

### 1. Field of the Invention

In the fields of science, technology, and engineering, many experiments and testing are conducted under vacuum conditions. Various components, including vacuum chambers and probes, are necessary to perform research and collect measurements. Components used in vacuum based research must be able to withstand low vacuum and cryogenic conditions. Existing vacuum components are expensive. The present invention relates to a novel vacuum chamber and probe, and method for manufacturing same, for use in scientific and industry experimentation and/or testing.

The present invention relates to the use of additive manufacturing in connection with developing vacuum chambers and probes. There are different types of commercially available additive manufacturing devices. The present specification relates to vacuum pumping ports made with VAT-photopolymerization Digital Light Processing additive manufacturing. There have been prior publications concerning the use of Stereolithography in connection with vacuum applications, but the prior references do not establish a product or method that is useful for cryogenic applications, which is essential for physics and engineering research and/or testing.

Problems with existing vacuum components such as chambers and probes are cost, manufacturing, and manufacturing time. Cost is also a problem with potentially using other types of additive manufacturing techniques to create vacuum chambers and probes. When building a vacuum chamber, overpressure build up should always be considered and safety valves should be included in the system. If too much pressure builds up, components made using vat photopolymerization additive manufacturing techniques may not withstand extreme pressures and could explode.

### SUMMARY OF THE INVENTION

The present invention is a photopolymer resin multiport vacuum chamber (PMVC) and probe, and a method of manufacturing using Vat Photopolymerization Digital Light Processing via a printing bed that moves against a film that allows ultraviolet light. An alternative method of manufacture is stereolithography additive manufacturing. The multiport vacuum chamber disclosed herein withstands low vacuum levels and cryogenic temperatures. The multiport vacuum chamber disclosed herein can also be used as a component for an experimental probe.

The present invention is capable of cryogenic uses because the components made using the methods herein are capable of holding vacuum at low temperature and/or in contact with cryogenic liquids such as liquid nitrogen or liquid helium. The present invention is capable of holding vacuum down to a level below 30 mTorr in a range of temperatures near room temperature of 300 K and 2 mTorr at low temperatures of 2 K. This vacuum level is sufficient for temperature controlling a sample space between room temperature and 2K. This is useful in many industries where samples need to be temperature controlled.

The present specification addresses the requirements to make inexpensive vacuum chambers useful for cryogenic applications using Vat Photopolymerization such as Digital Light Processing or Stereolithography additive manufacturing techniques. In order to be useful for cryogenic applications, the vacuum chamber must have several pumping ports that effectively couple with KF and/or ISO standard ports through the use of standard clamps, bolts and standard O-rings.

For vacuum components in a closed system, with or without a probe, a sufficiently low inner temperature in the enclosure will condense gas in liquid and/or solid phase. If there is a small leak and the low temperature is maintained for sufficient time, a decent amount of gas would be stored in liquid or solid phase inside the component. If unnoticed, and the temperature of the insert is allowed to increase, the liquid or solid air inside the insert becomes gas and therefore increases in pressure. Such a pressure increase can be a hazard that would be addressed by using a pressure release valve. The specification describes a way to produce cheap parts that are vacuum compatible and at the same time can withstand cryogenic conditions.

The present specification addresses the requirements to make inexpensive vacuum chambers useful for cryogenic applications manufactured using Vat Photopolymerization additive manufacturing techniques. This involves the presence of one or several pumping ports which need to couple well with KF/ISO standard ports through the use of standard clamps, bolts and standard O-rings. The lack of robustness is commensurate with the manufacturing price. Increasing wall thickness and the presence of embedded additional material help to increase robustness.

### BRIEF SUMMARY OF THE DRAWINGS

FIG. 1 is a perspective view of an embodiment of a multi-port vacuum chamber.

FIG. 2 is an environmental view of an embodiment of a multi-port vacuum chamber and an embodiment of a probe.

FIG. 3 is a front view of an embodiment of the multi-port vacuum chamber and an embodiment of the probe.

### DETAILED DESCRIPTION

The vacuum chamber 20 is manufactured using an Elegoo Mars 2 AM device or a Saturn S Digital Light Processing 3D printer or other suitable printing device. A load file is created and saved in stl format, converted to a format readable by the 3D printer device, and input into the same device.

The methods and devices described herein could also be performed with Stereolithography, which is a different type of Vat Photopolymerization additive manufacturing technique.

The vacuum chamber 20 is manufactured from a photopolymer resin composed of 50% epoxy resins, 40% hexamethylene diacrylate, 5% N-(Dimethylcarbamoyl) glycine and 5% hydroxycyclohexyl phenyl ketone. The resin solidifies when exposed to an ultraviolet radiation of 405 nm. The printing bed moves vertically up and down inside a pool of resin. The pool presented a floor of transparent plastic film. It is understood that other suitable photopolymer resins could be used.

Ultraviolet light is shone against the printing bed, solidifying the thin layer of photopolymer between bed and plastic film. At the time of production, that part which is being solidified is surrounded by liquid at room temperature which, in absence of bubbles, would leave a continuous layer of material, being the last surface printed of the same roughness as the thin plastic film against which it was printed. The main difference between both printers was the printing bed size. The piece is then surrounded by liquid at room temperature.

The vacuum chamber 20 was cured for 2 hours under Texas summer noon sunshine.

The vacuum chamber was washed with isopropyl alcohol several times after part production. Special care in preserving the quality of the vacuum surfaces was taken since parts which were parallel to the resin pool contained liquid film at the time of production. No residual photopolymer was left after being washed with alcohol and no scratches were present on the surface. Parts were left to either cure under sunshine, or in a Geetech curing box. While the former method is cheaper, the latter provides more control in the curing process. After the curing process, those surfaces which were not printed parallel to the print bed were polished with sandpaper of decreasing grain size.

A photopolymer resin can 38 was also created using the method described in paragraphs [0014]-[0019]. After testing using the photopolymer resin can 38, it was determined that additional UV exposure would reduce the amount of outgassing. The photopolymer resin can 38 was subjected to an additional 30 minutes of UV exposure in the Geetech UV chamber, which successfully reduced outgassing.

The manufacturing process described above results in the manufactured component having a very smooth and continuous surface with areas of very low roughness. Smoothness is vital when forming a vacuum tight seal. The level of surface roughness of the vacuum chamber 20 after UV exposure was similar to that of a plastic film, which made it sufficient for vacuum seal with O-rings.

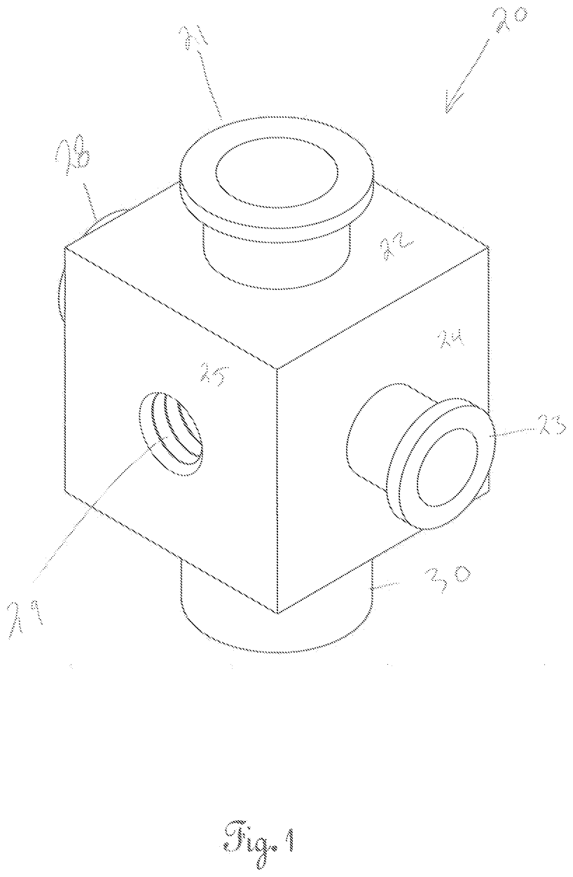

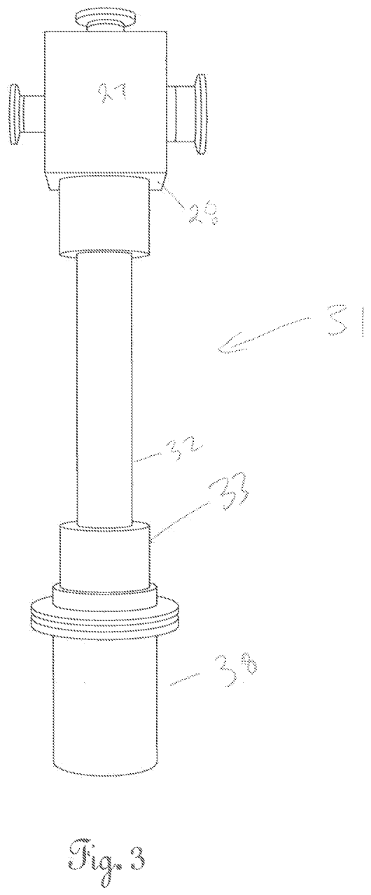

With reference to FIGS. 1 and 3, the multiport vacuum chamber 20 comprises a top surface 22, first side surface 24, second side surface 25, third side surface 26, fourth side surface 27, and a bottom surface 28. A KF25 port 21 is integral the top surface 22. A first KF16 port 23 is integral the first side surface 24. A second KF16 port 28 is integral the third side surface 26. A threaded aperture 29 is integrated into the second side surface 25. A fitting 30 is integrated into the bottom surface 28. Ideally, the fitting 30 is a cylindrical volume for receiving a three-fourths inch diameter PVC tube that can be posteriorly affixed to the fitting 30.

The threaded aperture 29 allows for a standard safety release valve to be threaded to the vacuum chamber 20. The fitting 30 allows the vacuum chamber 20 to be coupled with a component such as a probe. It is understood that the vacuum chamber could be configured with a different arrangement of ports and apertures.

The chamber wall thickness of the vacuum chamber 20 was 6 mm in order to maintain structural strength. At the ports, however, the wall thickness was reduced to 2 mm. The bottom part of the chamber included a cylindrical space to fit a ¾″ PVC tube that would posteriorly be permanently glued with Torr Seal, a low vapor glue from Agilent. It is understood that increasing wall thickness and the presence of embedded additional material help to increase robustness.

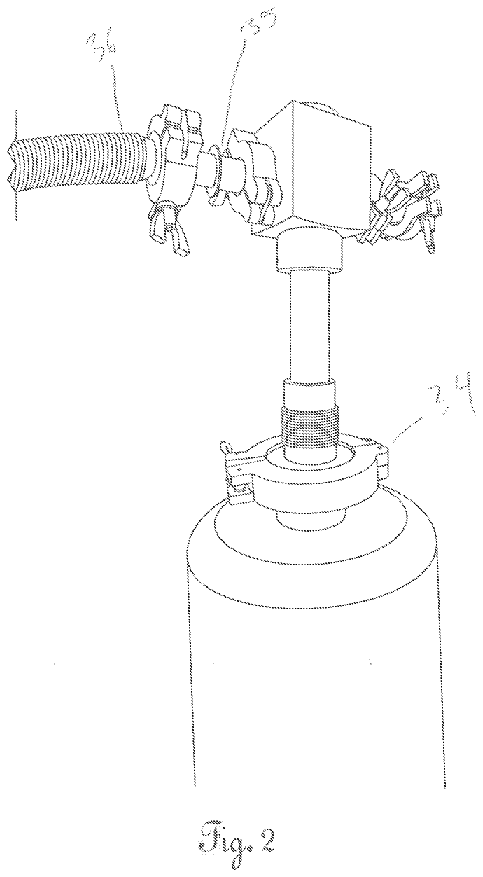

Referring to FIG. 2, the vacuum chamber 20 is shown being sued with a probe 31. The probe 31 comprises a shaft 32 and a KF50 to PVC adaptor 33 and a photopolymer resin can 38 with a KF50 flange that could connect with a standard KF50 O-Ring and clamp to the adaptor.

The probe 31 houses a temperature sensor (not shown) at the bottom end of the probe 31. A KF50 adaptor 34 connects the probe to a steel insert. The two KF16 ports 23 and 28 are connected to adapters 35 and conduits 36 that house wiring and other components (not shown). Vacuum tight clamps 37 are used to seal the intersection points. Ideally, a Kurt Lesker pressure gauge (not shown) is connected to one of the ports on the vacuum chamber 20.

The vacuum chamber 20 and probe 31 were tested for low temperatures with a Cryogenic Ltd 9.4 T cryogen free superconducting electromagnet with incorporated variable temperature sample space denoted as VTI. In this kind of system, a confined volume of helium is set to recirculate continuously passing through a charcoal filter, a helium liquefying system, a container, and the VTI via a needle valve. Inside the VTI, an enclosed stainless steel room temperature insert (RTI) was placed such that the recirculated helium gas is separated from the outside environment. The lowest part of the room temperature insert is allocated in the isothermal region of the VTI so the temperature in this region may be controlled from room temperature to liquid Helium temperatures. Cold helium gas goes from the needle valve to the VTI and from there it is sent back to a container through a 10 m³/h Edwards scroll pump. The magnet is capable of producing fields between 0 and 9.4 T and the recirculation system with any temperature inside the VTI between 2 K and 350 K.

Vacuum was established with a 3 m³/h oil Edwards pump, pumping on a 3D printed KF16 port on the side of the PMVC. The Kurt Lesker pressure gauge was connected at the top with a KF16 to KF25 adaptor. The remaining KF16 port was closed with a standard KF16 blank, O-ring, and clamp.

The probe components can be sealed with an epoxy to improve vacuum holding capabilities.

The vacuum chamber 20 can be produced for under $10 USD. The vacuum chamber 20 can support K16 and K25 ports and instrumentation clamped to those ports. The vacuum chamber 20 is capable of handling low temperatures and pressures near 2 mTorr.

I claim:

1. A method of manufacturing a multiport vacuum chamber using vat photopolymerization digital light processing additive manufacturing comprising the following steps:
creating a computer-aided design of the multiport vacuum chamber;
converting the computer-aided design of the multiport vacuum chamber into a file format readable by a vat photopolymerization digital light processing additive manufacturing printer;
inputting the computer-aided design of the multiport vacuum chamber into the vat photopolymerization digital light processing additive manufacturing printer;
inputting a photopolymer resin into the vat photopolymerization digital light processing additive manufacturing printer;
operating the vat photopolymerization digital light processing additive manufacturing printer to apply ultraviolet radiation to the photopolymer resin to print the multiport vacuum chamber;
curing the multiport vacuum chamber; and
washing the multiport vacuum chamber with isopropyl alcohol, ethanol, or water.

2. The method of claim 1 wherein:
the multiport vacuum chamber has a top surface, bottom surface, first surface, second surface, third surface, and fourth surface;
a KF25 port is integrated to the top surface;
a first KF16 port is integrated to the first surface;
a threaded aperture is integrated to the second surface;
a second KF16 port is integrated to the third surface; and
a fitting is integrated to the bottom surface.

3. The method of claim 1 wherein:
the photopolymer resin comprises 50% epoxy resins, 40% hexamethylene diacrylate, 5% N-(Dimethylcarbamoyl) glycine and 5% hydroxycyclohexyl phenyl ketone.

4. The method of claim 1 further comprising:
sanding the surfaces of the multiport vacuum chamber with a sandpaper of a first grain size; and
sanding the surface of the multiport vacuum chamber with a sandpaper of a second grain size, wherein the second grain size is smaller than the first grain size.

5. A multiport vacuum chamber comprising:
a multiport vacuum chamber printed using vat photopolymerization additive manufacturing.

6. The multiport vacuum chamber of claim 5 wherein:
the multiport vacuum chamber is made from a photopolymer resin comprising 50% epoxy resins, 40% hexamethylene diacrylate, 5% N-(Dimethylcarbamoyl) glycine and 5% hydroxycyclohexyl phenyl ketone.

7. The multiport vacuum chamber of claim 5 wherein the multiport vacuum chamber has at least one standard ISO port.

8. The multiport vacuum chamber of claim 5 wherein the multiport vacuum chamber has at least one standard KF port.

9. The multiport vacuum chamber of claim 5 wherein:
the multiport vacuum chamber has a top surface, bottom surface, first surface, second surface, third surface, and fourth surface;
a KF25 port is integrated to the top surface;
a first KF16 port is integrated to the first surface;
a threaded aperture is integrated to the second surface;
a second KF16 port is integrated to the third surface; and
a fitting is integrated to the bottom surface.

10. Multiport vacuum chamber made using vat photopolymerization additive manufacturing such as stereolithography or Digital Light Processing or other, consisting of a hollowed volume with standard ISO ports, fittings for standard tubes and O-rings that include the presence of a safety release valve or a hollow or fitting for one.

11. The multiport vacuum chamber of claim 10 wherein the material used for the manufacture of the walls of the chamber for vacuum with incorporated standard flanges and fittings as is made from photopolymer ranging from standard photopolymer resin to tough resin.

12. The multiport vacuum chamber of claim 10 wherein any or all the ISO standard port or ports embodied in the walls is one or more of either of the following types, KF10, KF16, KF 20, KF25, KF32, KF40, KF50, ISO 63, ISO 80, ISO 100, ISO 160, ISO 200, ISO 250, ISO 320, ISO 400, ISO 500 and ISO 630.

13. The multiport vacuum chamber of claim 10 wherein any or all of the ISO standard port or ports embodied in the walls of the chamber is one or more of either of the following types, CF1.33, CF2.75, CF4.50, CF6.00, CF8.00, CF10.00, CF12.00, CF14.00, CF16.50, CF2.12, CF3.38, CF4.62, CF6.75 and CF13.25.

14. Multiport vacuum chamber of claim 10 wherein an embodied tube ISO fitting with or without thread presents a tolerance to accept metallic or plastic tubes with ISO sizes with or without corresponding thread for posterior gluing or threading and can allow the tube to get in a proportional length inside the vacuum chamber or along all of it.

15. Multiport vacuum chamber of claim 10 wherein the stereolithography or any other vat-photopolymerization additive process manufactured body of the chamber may be made in two parts, which can be detached from each other and attached preserving vacuum with an O-ring in between being both parts compressed with either an ISO-KF clamp or with bolts that enter in the body of one of them, having this body holes with threads for this purpose.

16. Multiport vacuum chamber of claim 15, wherein one of the parts which is made with vat-photopolymerization additive manufacturing (such as stereolithography or Digital Light Processing) or the two of them presents an additional circular cavity to allocate an O-ring.

17. Multiport vacuum chamber of claim 10, wherein the vacuum chamber or one of its parts may be made of transparent resin.

18. Multiport vacuum chamber of claim 10, wherein the wall thickness is sufficient to hold a superior pressure than the limit of the safety release valve.

19. Multiport vacuum chamber as claimed in 10, wherein one of the ports presents and ISO thread to clamp a pressure release valve.
